(19) United States
(12) Patent Application Publication
(10) Pub. No.: US 2017/0214980 A1
(43) Pub. Date: Jul. 27, 2017

(54) METHOD AND SYSTEM FOR PRESENTING MEDIA CONTENT IN ENVIRONMENT

(71) Applicant: Hashplay Inc., San Francisco, CA (US)

(72) Inventor: Ingo Nadler, Bad Breisig (DE)

(21) Appl. No.: 15/411,178

(22) Filed: Jan. 20, 2017

Related U.S. Application Data
(60) Provisional application No. 62/281,211, filed on Jan. 21, 2016.

(51) Int. Cl. H04N 21/81; H04N 21/431; H04N 21/84; H04N 21/258; H04N 21/45; H04N 21/442; H04N 21/61; H04N 21/234

(52) U.S. Cl. CPC H04N 21/812; H04N 21/6125; H04N 21/4312; H04N 21/23418; H04N 21/25883; H04N 21/4532; H04N 21/44204; H04N 21/25891; H04N 21/84

(57) ABSTRACT

A method for presenting media content in an environment. The method includes determining at least one display region within the environment; sending a media request based on the determined at least one display region, wherein the media request comprises a plurality of request parameters; determining at least one media content to be displayed, based on the sent media request; receiving a response including a plurality of response parameters, wherein the plurality of response parameters are associated with the at least one media content; and displaying the at least one media content on the at least one display region, based on the received response.

### TECHNICAL FIELD

The present disclosure relates generally to virtual and augmented reality; and more specifically, to a method for presenting media content in an environment. Further, the present disclosure relates to a system for presenting media content in an environment.

### BACKGROUND

Nowadays, technologies such as virtual reality and augmented reality are increasingly being employed in day-to-day lives of people for various purposes such as entertainment, educational training, scientific visualization and so forth. Specifically, users of specialized computing devices such as virtual reality headsets, virtual reality glasses, augmented reality headsets, and so forth, are able to experience immersion within an environment that is rendered on such computing devices. Often, such environments are interactive and modifiable according to positions and viewing directions of the users.

However, such environments are limited in their capability to present media content (such as audio media, visual media, and audio-visual media) therein. For example, advertising via presentation of media content within such virtual and augmented reality environments is difficult and may require specialized media formats. Further, there is lack of provisions for efficient media content delivery to the virtual and augmented reality environments rendered on the computing devices. For example, presently known techniques are not sufficiently developed to embed standard advertisement units within such environments for media content advertising. Therefore, responses of the users to the presented media content are difficult to measure and may be prone to errors. Consequently, the presented media content may not be user interest-specific and may deteriorate the users' viewing experience.

Furthermore, existing virtual reality and augmented reality technologies are prone to reduced media content inventory utilization. Specifically, due to the aforementioned limitations, the media content associated with the virtual and augmented reality environments is not efficiently presented within such environments. For example, advertising media inventory for a virtual reality environment may not be fully utilised, thereby, leading to reduced revenue from the virtual reality environment.

Therefore, in light of the foregoing discussion, there exists a need to overcome the aforementioned drawbacks associated with techniques for presenting media content in an environment.

### SUMMARY

The present disclosure seeks to provide a method for presenting media content in an environment.

The present disclosure also seeks to provide a system for presenting media content in an environment.

In one aspect, an embodiment of the present disclosure provides a method for presenting media content in an environment, the method comprises:
determining at least one display region within the environment;
sending a media request based on the determined at least one display region, wherein the media request comprises a plurality of request parameters;
determining at least one media content to be displayed, based on the sent media request;
receiving a response comprising a plurality of response parameters, wherein the plurality of response parameters are associated with the at least one media content; and
displaying the at least one media content on the at least one display region, based on the received response.

In another aspect, an embodiment of the present disclosure provides a system for presenting media content in an environment, the system comprises a computing device associated with a user and a server arrangement communicably coupled to the computing device via a network, wherein
the computing device is operable to determine at least one display region within the environment;
the computing device is operable to send a media request to the server arrangement based on the determined at least one display region, wherein the media request comprises a plurality of request parameters;
the server arrangement is operable to determine at least one media content to be displayed, based on the sent media request;
the computing device is operable to receive a response, from the server arrangement, comprising a plurality of response parameters, wherein the plurality of response parameters are associated with the at least one media content; and
the computing device is operable to display the at least one media content on the at least one display region, based on the received response.

Embodiments of the present disclosure substantially eliminate or at least partially address the aforementioned problems in the prior art, and enables in efficiently displaying media content, such as advertising media, within the environment, such as virtual and augmented reality environments.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a system for presenting media content in an environment, in accordance with an embodiment of the present disclosure;

FIG. 2 is a schematic illustration of an exemplary environment having exemplary display regions within the environment, in accordance with an embodiment of the present disclosure;

FIGS. 3 and 4 are schematic illustrations of exemplary options provided within an environment for selection of a user's preference, in accordance with various embodiments of the present disclosure; and

FIG. 5 is an illustration of steps of a method for presenting media content in an environment, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

### Glossary

Brief definitions of terms used throughout the present disclosure are given below.

The term “media content” refers to media content that is formed using at least one media format. Examples of such media formats include, but are not limited to, audio, image, text, and video. In an instance, the term “media content” also relates to media content, namely, content that is formed by a combination of at least two different media formats. Examples of such media content include, but are not limited to, audio-video content, stereoscopic image content (such as three-dimensional objects), and stereoscopic video content. Specifically, the media content may be presented in the environment for various purposes such as advertising, entertainment, education, and so forth.

The term “environment” refers to surroundings (or reality) of a user, that the user experiences and/or operates within. Specifically, such environment may be computer-mediated (or manipulated using a computer) to enhance the user's perception of the environment around him/her.

In one example, the term “environment” may relate to a computer generated, three-dimensional environment, designed for providing the user with an immersive experience of virtual reality (or a virtual world). Hereinafter, such environment may also be known as a “virtual environment”. Specifically, the virtual environment may be rendered by presenting two distinct perspectives of a scene (such as left and right perspective views of the scene) to the user, by employing a technique such as stereoscopy, to provide a perception of depth within the scene. For example, the user may interact with other users and virtual objects within the virtual environment for a realistic virtual reality experience. Specifically, the user can change his/her position and/or viewing direction to invoke interaction with the virtual objects within the virtual environment.

In another example, the term “environment” may relate to a real-world environment of the user including virtual objects overlaid thereon. Specifically, such virtual objects may be computer generated and interactive, thereby making the real-world environment of the user susceptible to being digitally manipulated. For example, such virtual objects may be superimposed on a monoscopic or stereoscopic video stream of the real-world environment of the user by utilising layering information of surfaces in the real-world environment. Specifically, such virtual objects may be interactively changed depending on the user's position and/or viewing direction. Hereinafter, such real-world environment of the user including virtual objects overlaid thereon, may also be known as an “augmented reality environment”.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based upon the present disclosure provided herein, one of ordinary skill in the art will appreciate a variety of ways in which connection or coupling exists in accordance with the aforementioned definition.

The terms “first”, “second”, and the like, herein do not denote any order, quantity, or importance, but rather are used to distinguish one element from another. Furthermore, the terms “a” and “an” herein do not denote a limitation of quantity, but rather denote the presence of at least one of the referenced item.

The phrases “in an embodiment”, “in accordance with an embodiment” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

### EMBODIMENTS OF THE PRESENT DISCLOSURE

In a first aspect, an embodiment of the present disclosure provides a method for presenting media content in an environment, the method comprises:
determining at least one display region within the environment;
sending a media request based on the determined at least one display region, wherein the media request comprises a plurality of request parameters;
determining at least one media content to be displayed, based on the sent media request;
receiving a response comprising a plurality of response parameters, wherein the plurality of response parameters are associated with the at least one media content; and
displaying the at least one media content on the at least one display region, based on the received response.

In a second aspect, an embodiment of the present disclosure provides a system for presenting media content in an environment, the system comprises a computing device associated with a user and a server arrangement communicably coupled to the computing device via a network, wherein
the computing device is operable to determine at least one display region within the environment;
the computing device is operable to send a media request to the server arrangement based on the determined at least one display region, wherein the media request comprises a plurality of request parameters;
the server arrangement is operable to determine at least one media content to be displayed, based on the sent media request;
the computing device is operable to receive a response, from the server arrangement, comprising a plurality of response parameters, wherein the plurality of response parameters are associated with the at least one media content; and
the computing device is operable to display the at least one media content on the at least one display region, based on the received response.

The system for presenting media content in an environment comprises a computing device associated with a user and a server arrangement communicably coupled to the computing device via a network.

According to an embodiment of the present disclosure, the term “computing device” used herein relates to specialized equipment for rendering the environment. Specifically, the computing device may be operable by the user, to render the virtual environment and/or the augmented reality environment. More specifically, a virtual reality application may be executed on the computing device to render the virtual environment. Similarly, an augmented reality application may be executed on the computing device to render the augmented reality environment by overlaying virtual objects on the real-world environment of the user.

Examples of computing devices operable to render the virtual environment include, but are not limited to, virtual reality headsets, virtual reality goggles and virtual reality glasses. Similarly, examples of computing devices operable to render the augmented reality environment include, but are not limited to, augmented reality headsets, augmented reality glasses, camera-enabled tablet computers, and smartphones. Specifically, the computing device operable to render the augmented reality environment may include at least one camera to capture a monoscopic or stereoscopic video stream of the real-world environment of the user. In an example, the at least one camera may be a digital camera and/or a stereoscopic camera.

In an embodiment, the server arrangement may be hardware, software, firmware, or a combination of these, operable to facilitate presentation of the media content in the environment. In another embodiment, examples of the network include, but are not limited to, Internet and radio network.

The method for presenting media content in an environment comprises determining at least one display region within the environment. The computing device is operable to determine the at least one display region within the environment. Specifically, the at least one display region may relate to two-dimensional display regions (such as surfaces) or three-dimensional display regions (such as spatial areas) within the environment, that may be suitable for presenting media content. More specifically, it is to be understood that the at least one display region may relate to at least one area within the environment whereat presentation of media content may not interfere with (or hamper) the user's perception of the environment around him/her. For example, the at least one display region may comprise at least one empty space within the environment.

In an example, a two-dimensional display region within a virtual environment may be a surface of a wall therein. In another example, a three-dimensional display region within the virtual environment may be an unoccupied corner of a room therein. In yet another example, a two-dimensional display region within an augmented reality environment may be a floor surface whereat the user may be positioned.

Optionally, the at least one display region within the environment may comprise the entire environment. Specifically, every surface and spatial area of such environment may be utilized for presentation of the media content. For example, such environment may be known as ‘media-enriched environment’.

Optionally, the computing device may comprise a memory unit, wherein the memory unit may be hardware, software, firmware, or a combination of these, operable to store and maintain a list of the determined at least one display region within the environment.

According to an embodiment, the at least one display region may be determined by employing at least one of: image analysis algorithm, depth sensing within the environment, pattern recognition algorithm, empty space detection within the environment. Specifically, at least one of the aforementioned techniques may be implemented to identify (or detect) the at least one display region within the environment.

In an example, an image analysis algorithm may be employed to determine the at least one display region. Specifically, the image analysis algorithm may identify flat or empty surfaces within the monoscopic or stereoscopic video stream of the real-world environment of the user, obtained via the at least one camera of the computing device operable to render the augmented reality environment. In another example, the image analysis algorithm may be employed to find empty surfaces within a cube map of an object in the virtual environment. Examples of such image analysis algorithm include, but are not limited to, bounding edge detection algorithm and geometry reconstruction algorithm.

In another example, depth sensing within the environment may be employed to determine the at least one display region. Specifically, at least one three-dimensional depth sensor coupled to the computing device operable to render the augmented reality environment, may be used to identify the flat or empty surfaces within the monoscopic or stereoscopic video stream of the real-world environment of the user. In one example, the three-dimensional depth sensor may be a three-dimensional camera of the computing device. In another example, the three-dimensional depth sensor may be an ultrasonic sensor.

In another example, a pattern recognition algorithm may be employed to determine the at least one display region. Specifically, in such example, the pattern recognition algorithm may identify motifs/designs within the video stream of the real-world environment of the user. In another example, the pattern recognition algorithm may also be employed to identify motifs/designs within the left and right perspective views of a scene that collectively constitute the virtual environment of the scene. Optionally, such a motif/design may be a Quick Response Code within the environment.

In yet another example, empty space detection within the environment may be employed to determine the at least one display region. Specifically, in one instance, a bounding box (such as a cubical or a cuboidal region) of empty space may be identified between objects in the video stream of the real-world environment of the user, using suitable algorithms.

The method for presenting media content in the environment further comprises sending a media request based on the determined at least one display region, wherein the media request comprises a plurality of request parameters. The computing device is operable to send the media request to the server arrangement based on the determined at least one display region, wherein the media request comprises the plurality of request parameters. Specifically, the media request may be prepared and sent by the computing device by taking under consideration at least one of: dimensions (or size) of the at least one display region, position of the at least one display region within the environment (such as a corner position, a central position, and so forth), attributes (such as appearance, theme, and so forth) of the environment.

In an embodiment, the plurality of request parameters may comprise at least one of: a type of the media content, a size of the media content, at least one contextual keyword pertaining to the media content, an interest category of the media content. In such embodiment, the requested type of the media content may be suitable in accordance with the attributes of the environment and/or the position of the at least one display region within the environment. Further, in such embodiment, the requested size of the media content may be suitable to be accommodated within the determined at least one display region. Furthermore, the at least one contextual keyword pertaining to the media content may be related to the attributes of environment. Specifically, the contextual keyword may be directly related to users (or audience) to be targeted via the requested media content. Furthermore, the interest category of the media content may relate to interests of the users (or audience) to be targeted via the requested media content. Optionally, the media request may be sent in a prescribed format, such as a text file, to the server arrangement.

In one example, a media request comprising a plurality of request parameters, based on a determined display region may comprise a type of media content such as ‘audio-video advertisement content’, a size of the media content, such as ‘1280*720 pixels’, at least one contextual keyword pertaining to the media content, such as ‘nutrition’, ‘health’ and ‘fitness’, and an interest category of the media content, such as ‘food’.

Examples of the type of media content include, but are not limited to, audio content, image content, text content, video content, and audio-video content.

The method for presenting media content in the environment further comprises determining at least one media content to be displayed, based on the sent media request. The server arrangement is operable to determine the at least one media content to be displayed, based on the sent media request. Specifically, the server arrangement may process the sent media request to determine the at least one media content to be displayed.

Optionally, the server arrangement may further comprise a database operable to store a plurality of media content comprising the at least one media content. Specifically, the server arrangement may process the sent media request to identify the at least one media content from among the plurality of media content stored at the database, such that the at least one media content satisfies (or meets requirements specified in) the plurality of request parameters. Further, the server arrangement may also take into account availability of the stored plurality of media content.

For example, the server arrangement may compare the plurality of request parameters in the media request with parameters/attributes of each of the plurality of media content to determine the at least one media content to be displayed.

Optionally, the plurality of media content comprising the at least one media content may be stored on at least one network device (such as remote database servers) external to the server arrangement. In such instance, the server arrangement may communicate with the at least one network device to determine the at least one media content to be displayed.

In an embodiment, the at least one media content may comprise at least one of: a two-dimensional advertisement, a three-dimensional advertisement. Specifically, the server arrangement may determine at least one two and/or three-dimensional advertisement depending on the plurality of request parameters in the sent media request. Further, such two and/or three-dimensional advertisement may be determined in accordance with the interests of the users (or audience) to be targeted via the presented media content.

For example, at least one media content may comprise a two-dimensional image advertisement for woolen clothing. In another example, at least one media content may comprise a two-dimensional video advertisement for a paid preview of a movie. In another example, at least one media content may comprise a monoscopic and/or a stereoscopic video advertisement. In yet another example, at least one media content may comprise a monoscopic and/or a stereoscopic 360 degree video advertisement.

In another example, at least one media content may comprise a stereoscopic image advertisement (such as a three-dimensional object, for example, a model of designer furniture). In such example, the stereoscopic image advertisement may comprise at least two two-dimensional images (such as a left perspective view and a right perspective view) that may collectively constitute the stereoscopic image advertisement (such as the model of designer furniture) using stereoscopy.

The method for presenting the media content in the environment further comprises receiving a response comprising a plurality of response parameters, wherein the plurality of response parameters are associated with the at least one media content. The computing device is operable to receive the response, from the server arrangement, comprising a plurality of response parameters, wherein the plurality of response parameters are associated with the at least one media content. More specifically, the response may be a feedback from the server arrangement to the computing device, such that the response may include all requisite information for the computing device to fetch the determined at least one media content to be displayed.

Optionally, the response may have a pre-determined format such as text format. Examples of the pre-determined format include, but are not limited to, Extensible Markup Language format, JavaScript Object Notation, and HyperText Markup Language.

In an embodiment, the plurality of response parameters may comprise at least one of: a network address of the at least one media content, a type of the at least one media content, an interest category of the at least one media content, a delivery tracking network address, an interest tracking network address, a click response network address.

For example, the network address of the at least one media content may be a Uniform Resource Locator (or URL) thereof. Specifically, such network address may specify location of the at least one media content on the server arrangement or the at least one network device. Further, the type of the at least one media content, specified in the response may be same as the type of media content requested in the sent media request. Optionally, the type of the at least one media content may differ from the type of media content requested in the sent media request, for instance, in the event of lack of availability of the type of media content requested.

In another example, the delivery tracking network address may specify a network location that may record occurrences of display of the determined at least one media (upon display thereof), the interest tracking network address may specify a network location that may record the user's visual interest in the at least one media to be displayed, and the click response network address may specify a network location that the user may be redirected to, if the user clicks on the at least one media to be displayed.

Thereafter, the method for presenting the media content in the environment further comprises displaying the at least one media content on the at least one display region, based on the received response. The computing device is operable to display the at least one media content on the at least one display region, based on the received response. Specifically, the at least one media content may be displayed to constitute a surface texture of the at least one display region.

For example, if a media content is a two-dimensional image advertisement, the media content may be superimposed upon the at least one display region. In another example, if a media content is a monoscopic video advertisement, the media content may have a same perspective for both eyes of the user, and may be rendered on the at least one display region with minimal processing. Alternatively, if the media content is a stereoscopic video advertisement, the media content may be processed and displayed such that a left eye perspective view of the stereoscopic video advertisement may be focused onto a left eye of the user and a right eye perspective view of the stereoscopic video advertisement may be focused onto a right eye of the user.

In another example, if a media content is a monoscopic 360 degree video advertisement, the media content may be displayed on a spherical display region such that the user is positioned at a centre thereof. Specifically, such media content may have a same perspective for both eyes of the user. Similarly, if the media content is a stereoscopic 360 degree video advertisement, the media content may be displayed on a spherical display region such that the user is positioned at a centre thereof. However, the media content may be processed to split into two parts and displayed such that a left eye perspective view of the stereoscopic 360 degree video advertisement may be focused onto a part of the spherical display region that lies in field of view of the left eye of the user, and a right eye perspective view of the stereoscopic 360 degree video advertisement may be focused onto another part of the spherical display region that lies in field of view of the right eye of the user. In such examples, the computing device may be operable to render the environment and seamlessly change to render the spherical display region. Similarly, the computing device may be operable to render the spherical display region and seamlessly change to render the environment.

In yet another example, if a media content is a stereoscopic image advertisement, the media may be superimposed upon the monoscopic or stereoscopic video stream of the real-world environment of the user by utilising layering information of the at least one display region in the real-world environment. Specifically, such media content may be perceptively warped to match spatial orientation of the at least one display region prior to superimposition on the video stream of the real-world environment of the user. More specifically, left and right perspective views of the stereoscopic image advertisement may be separately processed and displayed to appear three-dimensional. Optionally, the stereoscopic image advertisement may be rendered within the virtual environment after requisite processing such as rotation, scaling, resizing, and translation to fit within the determined at least one display region such as the bounding box. More optionally, the virtual environment may be adapted to seamlessly integrate the stereoscopic image advertisement therein, by adjustment of lighting within the environment.

In one embodiment, in the media-enriched environment described previously, the media content may comprise stereoscopic text and/or two-dimensional text. For example, a media-enriched environment may comprise a network address of the at least one media content as stereoscopic text.

According to an embodiment, the method may further comprise providing at least one option within the environment, and adjusting display of the at least one media content on the at least one display region, based on a selection of the at least one option. Specifically, the at least one option may be provided prior to displaying the at least one media content on the at least one display region. More specifically, the at least one option may be provided in form of at least one of buttons, text, icons, drop down lists, graphs, tabs, and so forth. For example, the at least one option may be provided in text and button form, such as a textual question having at least one response in form of buttons. Optionally, the at least one media content may not be displayed until selection of the at least one option by the user.

In an embodiment, the at least one option may comprise at least one of: an option for displaying the at least one media content, an option for suppressing the display of the at least one media content by payment of a fee. Specifically, the at least one option may provide a choice to the user, such choice pertaining to whether or not to view the at least one media content. Therefore, selection of the at least one option may be indicative of preference of the user with regards to the at least one media content to be displayed. Further, the fee to be paid for suppressing the display of the at least one media content may be minimal (such as a micropayment), and may be displayed along with the corresponding option. Consequently, upon selection of the option for suppressing the display of the at least one media content by payment of a fee, different modes of fee payment such as digital wallets, payment gateways, and so forth, may be presented to the user for completing the fee payment transaction. In such instance, upon completion of the fee payment transaction, the display of the at least one media content may be suppressed, regardless of duration thereof.

In another embodiment, the at least one option may comprise an option for suppressing the display of the at least one media content for a pre-determined time period, by payment of a fee. Specifically, such pre-determined time period may be displayed along with such corresponding option. For example, the pre-determined time period may be 30 minutes, 60 minutes, 90 minutes, 120 minutes, and so forth.

Beneficially, the at least one option may be utilised in instances wherein the at least one media content comprises two-dimensional and/or three-dimensional advertisements. In such instances, the user may prefer to suppress the display of the at least one media content by payment of the fee. In such instances, if the user opts to suppress the display of the at least one media content, a number of available display regions reduces, thereby, leading to optimal utilization of advertising media inventory for the environment.

In an embodiment, selection of the option for displaying the at least one media content may further provide an option for selecting at least one network address of the plurality of response parameters. Specifically, the at least one network address of the plurality of response parameters may be displayed along with the at least one media content. More specifically, the user may select the option for selecting at least one network address in order to know more about the displayed at least one media content. For example, the user may select an option for selecting a network address of a two-dimensional advertisement of a shoe in order to view more information about the shoe. In such instance, the aforementioned network address may be a network address associated with a manufacturer of the shoe.

According to an embodiment, the method may further comprise preparing an interest category list comprising a plurality of media content interests of a plurality of users, and updating the interest category list based on at least one of a plurality of interest categories received in a plurality of media requests, a viewing time spent by a user in viewing the displayed at least one media content on the at least one display region, and number of clicks on the displayed at least one media content. In such embodiment, the server arrangement is operable to prepare and update the interest category list. Specifically, the interest category list may be a systematic record of the plurality of media content interests of the plurality of users. More specifically, the interest category list may be prepared, based on selection of the provided at least one option, by the plurality of users. Further, the plurality of media content interests of the plurality of users includes interest categories of the at least one media content that is preferred by the user. Optionally the plurality of media content interests may also include the at least one media content.

For example, if a user frequently selects an option for suppressing display of an advertisement of computer peripherals and frequently selects an option for displaying an advertisement of non-fiction novels, the interest category list associated with the user, may include an interest category ‘non-fiction novels’ and may not include media content having an interest category ‘computer peripherals’. In such example, the media requests associated with the user may include ‘non-fiction novels’ as an interest category of the at least one media content.

In another example, if the viewing time spent by a user in viewing the displayed at least one media content on the at least one display region is high, the interest category list may be updated to include the interest category of the displayed at least one media content. Optionally, the viewing time spent by the user in viewing the displayed at least one media content may be compared against a pre-determined time period. In such instance, if the viewing time spent by the user is greater that the pre-determined time period, the interest category of the displayed at least one media content may be added to the interest category list. Alternatively, if the viewing time spent by the user is lesser that the pre-determined time period, the interest category of the displayed at least one media content may be removed from the interest category list

In yet another example, the interest category list may be updated based on the number of clicks on the displayed at least one media content. Specifically, upon a high number of clicks by the user on the displayed at least one media content, an interest category of the displayed at least one media content may be added to the interest category list. Alternatively, upon a low or nil number of clicks by the user on the displayed at least one media content, an interest category of the displayed at least one media content may be removed from the interest category list.

According to an embodiment, the database of the server arrangement may be operable to store the interest category list.

According to an embodiment, the method may further comprise sending tracking information to at least one network address of the plurality of response parameters based on: display of the at least one media content on the at least one display region, the viewing time spent by the user in viewing the displayed at least one media content, the number of clicks on the displayed at least one media content. Specifically, the tracking information may be sent by the computing device to the server arrangement, for monitoring interest of the users to be targeted via the determined at least one media content. More specifically, the server arrangement may determine the at least one media content to be displayed, based on such tracking information. It is to be understood that such tracking information may consequently optimize display of the at least one media content in the environment, thereby significantly enhancing the user's perception and experience of the environment. For example, such tracking information may be beneficial for advertising campaigns wherein interest of a user with regards to a displayed two-dimensional or three-dimensional advertisement may be tracked, in order to subsequently display relevant or interest-specific advertisements to the user. In example, the tracking information may further comprise impression tracking data pertaining to the displayed at least one media content.

In an example, a number of times the user selected an option for displaying a media content, may be sent to the delivery tracking network address. In another example, the viewing time spent by the user in viewing the displayed at least one media content may be sent to the interest tracking network address. In yet another example, the number of clicks on the displayed at least one media content may be sent to the click response network address.

The present disclosure provides a method and a system for presenting media content in an environment. Specifically, the method and the system of the present disclosure enables in displaying media content, such as advertisement content within the environment, i.e. virtual and augmented reality environments. Further, the advertising content may be one of audio media, visual media, audio-visual media; and may be a two-dimensional advertisement or a three-dimensional advertisement. The advertisement content is displayed based on available display region (in the environment), media request parameters and selection by users' preference. This allows selection of suitable media content to be appropriately rendered on the environment. Also, the media content is based on the contextual keyword pertaining to the media content and/or an interest category of the media content. Therefore, the presented media content is user interest-specific and does not deteriorate the users' viewing experience. Additionally, the present disclosure enables efficient utilization of advertising media inventory in the virtual and augmented reality environments, which can act as an enhanced revenue generation aspect in the field of virtual and augmented reality environments.

### DETAILED DESCRIPTION OF THE DRAWINGS

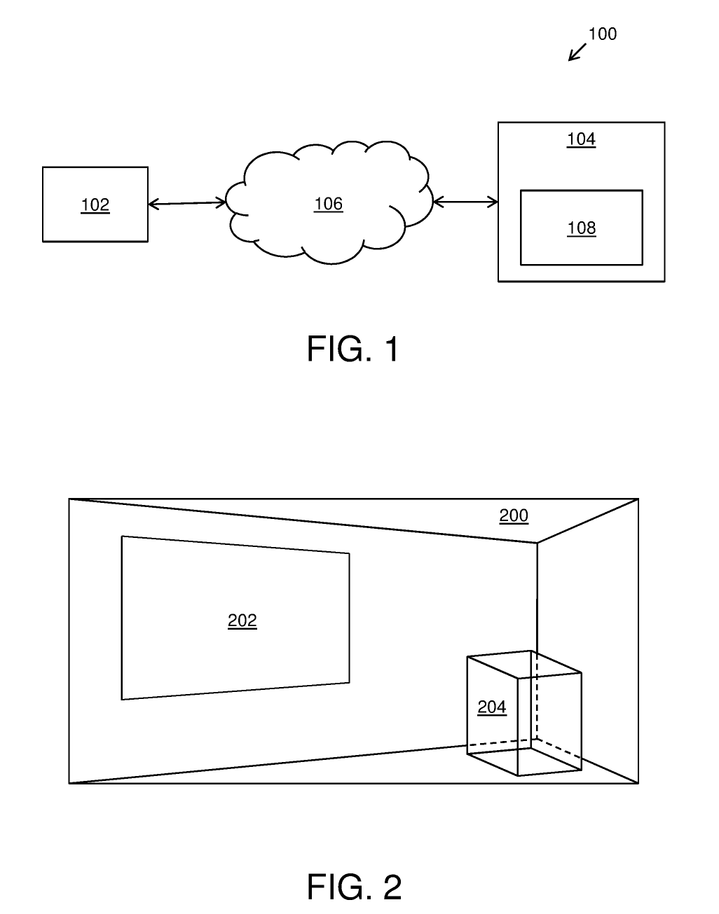

Referring to FIG. 1, illustrated is a schematic illustration of a system 100 for presenting media content in an environment, in accordance with an embodiment of the present disclosure. The system 100 includes a computing device 102 associated with a user (not shown) and a server arrangement 104 communicably coupled to the computing device via a network 106. The server arrangement 104 includes a database 108.

FIG. 1 is merely an example, which should not unduly limit the scope of the claims herein. A person skilled in the art will recognize many variations, alternatives, and modifications of embodiments of the present disclosure.

Referring to FIG. 2, illustrated is a schematic illustration of an exemplary environment 200 having exemplary display regions within the environment 200, in accordance with an embodiment of the present disclosure. As shown, the environment 200 includes a two-dimensional display region 202 and a three-dimensional display region 204. For example, the two-dimensional and three-dimensional display regions 202, 204 may be used for rendering two-dimensional advertisement and three-dimensional advertisement, respectively, thereon.

FIG. 2 is merely an example, which should not unduly limit the scope of the claims herein. A person skilled in the art will recognize many variations, alternatives, and modifications of embodiments of the present disclosure.

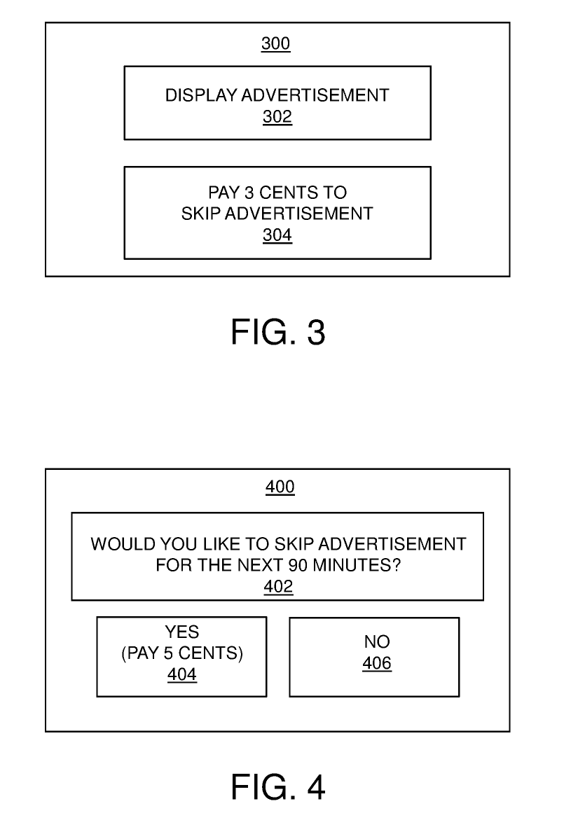

Referring to FIGS. 3 and 4, illustrated are schematic illustrations of exemplary options provided within an environment 300 for selection of a user's preference, in accordance with various embodiments of the present disclosure. As shown, FIG. 3 depicts at least one option (depicted as buttons) within the environment 300, such as an option “DISPLAY ADVERTISEMENT” 302, a selection of which displays media content, i.e. the advertisement, on at least one display region within the environment 300. The environment 300 also includes an option such as an option “PAY 3 CENTS TO SKIP ADVERTISEMENT” 304, a selection of which suppresses display of the media content. Similarly, as shown in FIG. 4, an environment 400 includes at least one option (depicted as buttons) within the environment 400, such as an option “WOULD YOU LIKE TO SKIP ADVERTISEMENT FOR THE NEXT 90 MINUTES?” 402, which is posed as a question to a user as to whether the user is willing to skip viewing of media content, i.e. the advertisement for a pre-determined time period of 90 minutes. The environment 400 further includes options (or buttons), such as an option “YES (PAY 5 CENTS)” 404 and an option “No” 406, for obtaining the user's preference. It is to be understood that, selection of the option “YES (PAY 5 CENTS)” 404 would suppress display of the media content for the next 90 minutes, and selection of the option “No” 406 would display the media content on the environment.

FIGS. 3 and 4 are merely examples, which should not unduly limit the scope of the claims herein. A person skilled in the art will recognize many variations, alternatives, and modifications of embodiments of the present disclosure.

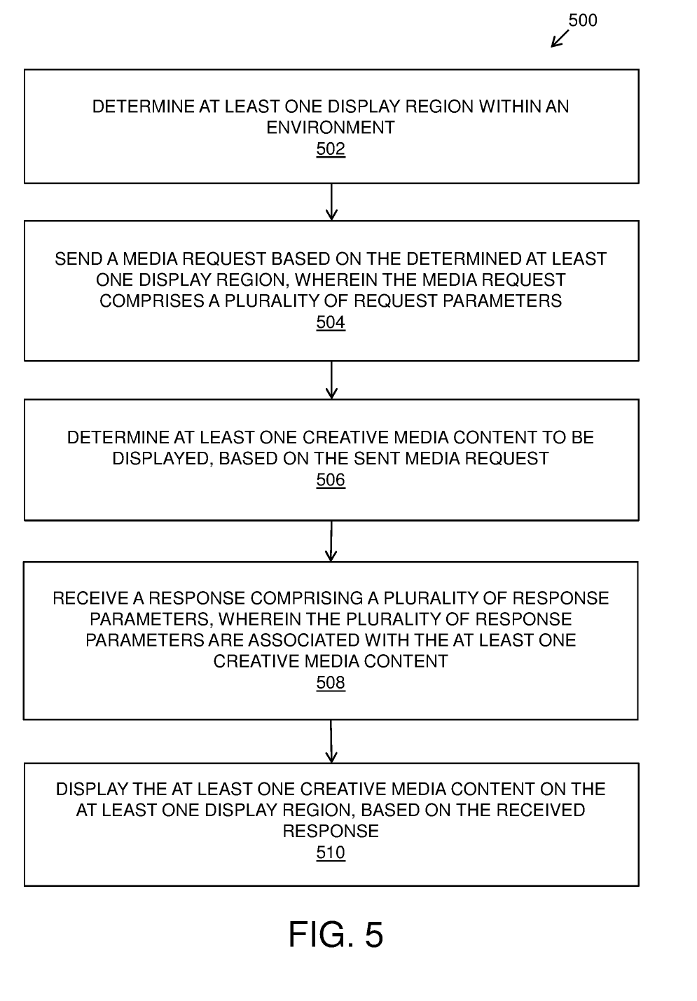

Referring to FIG. 5, illustrated are steps of a method 500 for presenting media content in an environment, in accordance with an embodiment of the present disclosure.

At step 502, at least one display region is determined within the environment. At step 504, a media request is sent based on the determined at least one display region, wherein the media request comprises a plurality of request parameters. At step 506, at least one media content to be displayed is determined, based on the sent media request. At step 508, a response comprising a plurality of response parameters is received, wherein the plurality of response parameters are associated with the at least one media content. At step 510, the at least one media content is displayed on the at least one display region, based on the received response.

The steps 502 to 510 are only illustrative and other alternatives can also be provided where one or more steps are added, one or more steps are removed, or one or more steps are provided in a different sequence without departing from the scope of the claims herein. For example, in the method 500, the at least one display region may be determined by employing at least one of: image analysis algorithm, depth sensing within the environment, pattern recognition algorithm, empty space detection within the environment. Further, the at least one media content may include at least one of: a two-dimensional advertisement, a three-dimensional advertisement. Furthermore, the plurality of request parameters may include at least one of: a type of the media content, a size of the media content, at least one contextual keyword pertaining to the media content, an interest category of the media content. Moreover, the plurality of response parameters may include at least one of: a network address of the at least one media content, a type of the at least one media content, an interest category of the at least one media content, a delivery tracking network address, an interest tracking network address, a click response network address.

The method 500 may further include providing at least one option within the environment; and adjusting display of the at least one media content on the at least one display region, based on a selection of the at least one option. Further, the at least one option may include at least one of: an option for displaying the at least one media content, an option for suppressing the display of the at least one media content by payment of a fee. Further, in the method 500. Furthermore, the selection of the option for displaying the at least one media content further provides an option for selecting at least one network address of the plurality of response parameters.

The method 500 may further include preparing an interest category list having a plurality of media content interests of a plurality of users; and updating the interest category list based on at least one of a plurality of interest categories received in a plurality of media requests, a viewing time spent by a user in viewing the displayed at least one media content on the at least one display region, and number of clicks on the displayed at least one media content. Further, the method 500 may include sending tracking information to at least one network address of the plurality of response parameters based on: display of the at least one media content on the at least one display region, the viewing time spent by the user in viewing the displayed at least one media content, the number of clicks on the displayed at least one media content.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for presenting media content in an environment, the method comprising:
determining at least one display region within the environment;
sending a media request based on the determined at least one display region, wherein the media request comprises a plurality of request parameters;
determining at least one media content to be displayed, based on the sent media request;
receiving a response comprising a plurality of response parameters, wherein the plurality of response parameters are associated with the at least one media content; and
displaying the at least one media content on the at least one display region, based on the received response.

2. A method according to claim 1, wherein the at least one display region is determined by employing at least one of: image analysis algorithm, depth sensing within the environment, pattern recognition algorithm, empty space detection within the environment.

3. A method according to claim 1, wherein the at least one media content comprises at least one of: a two-dimensional advertisement, a three-dimensional advertisement.

4. A method according to claim 1, wherein the plurality of request parameters comprises at least one of: a type of the media content, a size of the media content, at least one contextual keyword pertaining to the media content, an interest category of the media content.

5. A method according to claim 1, wherein the plurality of response parameters comprises at least one of: a network address of the at least one media content, a type of the at least one media content, an interest category of the at least one media content, a delivery tracking network address, an interest tracking network address, a click response network address.

6. A method according to claim 1, further comprising:
providing at least one option within the environment; and
adjusting display of the at least one media content on the at least one display region, based on a selection of the at least one option.

7. A method according to claim 6, wherein the at least one option comprises at least one of: an option for displaying the at least one media content, an option for suppressing the display of the at least one media content by payment of a fee.

8. A method according to claim 7, wherein selection of the option for displaying the at least one media content further provides an option for selecting at least one network address of the plurality of response parameters.

9. A method according to claim 1, further comprising:
preparing an interest category list comprising a plurality of media content interests of a plurality of users; and
updating the interest category list based on at least one of a plurality of interest categories received in a plurality of media requests, a viewing time spent by a user in viewing the displayed at least one media content on the at least one display region, and number of clicks on the displayed at least one media content.

10. A method according to claim 8, further comprising sending tracking information to at least one network address of the plurality of response parameters based on: display of the at least one media content on the at least one display region, the viewing time spent by the user in viewing the displayed at least one media content, the number of clicks on the displayed at least one media content.

11. A system for presenting media content in an environment, the system comprising a computing device associated with a user and a server arrangement communicably coupled to the computing device via a network, characterized in that:
the computing device is operable to determine at least one display region within the environment;
the computing device is operable to send a media request to the server arrangement based on the determined at least one display region, wherein the media request comprises a plurality of request parameters;
the server arrangement is operable to determine at least one media content to be displayed, based on the sent media request;
the computing device is operable to receive a response, from the server arrangement, comprising a plurality of response parameters, wherein the plurality of response parameters are associated with the at least one media content; and
the computing device is operable to display the at least one media content on the at least one display region, based on the received response.

12. A system according to claim 11, wherein the server arrangement is operable to:
prepare an interest category list comprising a plurality of media content interests of a plurality of users associated with a plurality of computing devices; and
update the interest category list based on at least one of a plurality of interest categories received in a plurality of media requests, a viewing time spent by a user in viewing the displayed at least one media content on the at least one display region, and number of clicks on the displayed at least one media content.

13. A system according to claim 11, wherein the server arrangement further comprises a database operable to store a plurality of media content comprising the at least one media content.

14. A system according to claim 13, wherein the database is further operable to store the interest category list.
